(19) United States
(12) Patent Application Publication
(10) Pub. No.: US 2011/0027662 A1
(43) Pub. Date: Feb. 3, 2011

(54) LITHIUM ION SECONDARY BATTERY

(76) Inventors: Etsuko NISHIMURA, Hitachiota-shi (JP); Katsunori Nishimura, Hitachiota-shi (JP); Akihide Tanaka, Hitachinaka-shi (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/847,052

(22) Filed: Jul. 30, 2010

(30) Foreign Application Priority Data
Jul. 31, 2009 (JP) 2009-179734

(51) Int. Cl. H01M 10/02; H01M 10/052

(52) U.S. Cl. 429/323; 429/199

(57) ABSTRACT

A lithium ion secondary battery includes: a cathode that stores/releases lithium ion at a potential not lower than an oxidation-reduction equilibrium potential between halogen ion and halogen; an anode that stores/releases lithium ion, preferably containing carbon; and a non-aqueous electrolytic solution composed of a non-aqueous solvent having dissolved therein an electrolyte. The non-aqueous electrolytic solution contains lithium halide or a halogen molecule. Instead of the non-aqueous electrolytic solution, a polymer solid electrolyte containing lithium halide or halogen molecule may be used.

### INCORPORATION BY REFERENCE

The disclosure of Japanese Patent Application No. 2009-179734 filed Jul. 31, 2009 is herein incorporated by reference.

### BACKGROUND OF THE INVENTION

1. Field of the Invention

The present invention relates to a lithium ion secondary battery that can be used for a power source and various equipment systems. More particularly, the present invention is applicable to a lithium ion secondary battery for electric vehicles and for energy storage.

2. Description of Related Art

Rechargeable batteries with non-aqueous electrolytes, typically lithium ion secondary batteries, have high energy densities and attract attention as batteries for electric vehicles and for power storage. In particular, there are various types of electric vehicles, including a zero-emission electric vehicle without engines, a hybrid electric vehicle with an engine and a secondary battery, and a plug-in hybrid electric vehicle which uses only a secondary battery and a motor when it runs at a short distance whereas gasoline engine is driven when it runs at a long distance. In addition, lithium ion secondary batteries are hoped to serve as a stationary power storage system that stores power and supplies power in a time of emergency when the power system is cut off.

The variety of applications requires excellent durability of lithium ion secondary battery. More particularly, it is required that the lithium ion secondary battery has a low rechargeable capacity loss and high capacity retention for a long period of time even at an elevated ambient temperature. In particular, the lithium ion secondary battery for electric vehicles could suffer from radiation heat from road and heat conduction from the inside of the vehicle and hence it is exposed to a high temperature environment at 60° C. or higher. Thus, its important requisite performance includes storage property and cycle life of the battery in the high temperature ambient at 60° C. or higher.

Capacity loss or cycle deterioration of a lithium ion secondary battery upon storage at high temperatures has been conventionally controlled by the following known technologies (Patent References 1 to 7).

JP 2005-063717 A (Patent Reference 1) discloses a technology that involves forming a film of a metal halide on the surface of an anode active material with non-aqueous electrolytes containing the metal halide to control stress generated near an area where a collector and an active material layer contact each other in order to improve charge-discharge cyclability of a lithium ion secondary battery.

JP 2003-151626 A (Patent Reference 2) discloses a technology that improves charge-discharge efficiency and cycle life of a lithium ion secondary battery by using a polymer adsorbent having an ethylene oxide chain that can adsorb on lithium metal.

JP 3963090 B (Patent Reference 3) and JP H07-302617 A (Patent Reference 4) disclose inventions on improvement of discharge efficiency by forming a film of lithium iodide or the like on the anode.

JP H07-235297 A (Patent Reference 5) discloses a technology that involves mixing a lithium salt such as lithium iodide in the anode to allow a reaction between the lithium compound and fluoric acid to occur prior to a reaction between C₆Li and fluoric acid, thereby preventing lithium ion from being liberated from C₆Li.

JP H07-192760 A (Patent Reference 6) discloses an invention according to which a calcium salt is added to the electrolytes in order to prevent deterioration of the electrolytes (reaction between electrolytes and the negative material), thereby improving storage property of the battery.

JP 2009-016362 A (Patent Reference 7) discloses an invention according to which a redox shuttle composed of a compound having a benzene ring substituted with a halogen atom and a methoxy group is used in a 4-V-class battery such that the redox shuttle effectively functions to consume overcharge current effectively.

“Manual of Electrochemistry, 4th edition”, published by Maruzen Co., Ltd., pages 71 to 74 (Non-Patent Reference 1) describes on the equilibrium potential of oxidation-reduction reaction of 2I⁻/I₂ and the equilibrium potential of oxidation-reduction reaction of Li⁺/Li.

### SUMMARY OF THE INVENTION

Lithium ion secondary batteries for electric vehicles or for energy storage may sometimes be left to stand at high temperatures in a charged state and after this standing, loss of the capacity of the lithium ion secondary battery occurs. The capacity loss includes rechargeable capacity loss and non-rechargeable capacity loss. It is an object of the present invention to reduce non-rechargeable capacity loss from among the capacity loss that occurs when the lithium ion secondary battery is left to stand in a high temperature environment.

As a result of extensive research with a view to solving the above-mentioned problem, the inventors of the present invention have found means to reduce non-rechargeable capacity loss out of capacity loss encountered when a lithium ion secondary battery, which comprises: a cathode that stores/releases lithium ion at a potential not lower than an oxidation-reduction equilibrium potential between halogen ion and halogen; an anode that stores/releases lithium ion, preferably containing carbon; and a non-aqueous electrolytic solution composed of a non-aqueous solvent having dissolved therein an electrolyte, is left to stand in a high-temperature environment.

According to a first aspect of the present invention, there is provided a lithium ion secondary battery comprising: a cathode that stores/releases lithium ion at a potential not lower than an oxidation-reduction equilibrium potential between halogen ion and halogen; an anode that stores/releases lithium ion, preferably containing carbon; and a non-aqueous electrolytic solution composed of a non-aqueous solvent having dissolved therein an electrolyte, wherein the non-aqueous electrolytic solution contains lithium halide or a halogen molecule.

In the lithium ion secondary battery according to the first aspect, the content of the lithium halide or the halogen molecule is preferably in the range of 0.01 to 10 mmol/kg in terms of halogen based on weight of the non-aqueous electrolytic solution.

In the lithium ion secondary battery according to the first aspect, it is preferred that the lithium halogen or the halogen molecule adsorbed on a surface of the anode is removable by washing with the non-aqueous solvent.

According to a second aspect of the present invention, there is provided a lithium ion secondary battery comprising: a cathode that stores/releases lithium ion at a potential not lower than an oxidation-reduction equilibrium potential between halogen ion and halogen; an anode that stores/releases lithium ion, preferably containing carbon; and a polymer solid electrolyte containing an electrolyte, wherein the polymer solid electrolyte contains lithium halide or a halogen molecule.

In the lithium ion secondary battery according to the second aspect, it is preferred that the content of the lithium halide or the halogen molecule is in the range of 0.01 to 10 mmol/kg in terms of halogen based on weight of the non-aqueous electrolytic solution.

In the lithium ion secondary batteries according to the first and second aspects, it is preferred that the halogen ion is iodide ion and the halogen molecule is iodine molecule.

In the lithium ion secondary batteries according to the first and second aspects, it is preferred that the anode comprises a material selected from the group consisting of carbon, a metal that forms an alloy with lithium, and mixtures thereof.

According to a third aspect of the present invention, there is provided a lithium ion secondary battery comprising: a cathode that stores/releases lithium ion at a potential not lower than an oxidation-reduction equilibrium potential between halogen ion and halogen; an anode that stores/releases lithium ion, preferably containing carbon; and an electrolyte, wherein the electrolyte contains an inorganic redox shuttle, the cathode stores/releases lithium at a potential not lower than an oxidation-reduction equilibrium potential of the inorganic redox shuttle.

In the lithium ion secondary battery according to the third aspect, it is preferred that the inorganic redox shuttle comprises halogen.

According to a fourth aspect of the present invention, there is provided a lithium ion secondary battery comprising: a cathode that electrochemically insert/extract lithium ion; an anode that electrochemically insert/extract the lithium ion; and an electrolyte, wherein the electrolyte comprises an oxidation-reduction reaction system coupled with the electrochemical insertion/extraction reaction of the lithium ion, the cathode stores/releases lithium at a potential not lower than an oxidation-reduction equilibrium potential of the oxidation-reduction system.

According to the present invention, capacity loss, in particular, irreversible capacity loss at high temperatures, of a lithium ion secondary battery can be reduced.

### BRIEF DESCRIPTION OF THE DRAWINGS

FIG. 1 is a cross-sectional view showing a cylindrical lithium ion secondary battery according an embodiment of the present invention.

FIG. 2 is a graph illustrating capacity retention property of an anode with the electrolytic solution according to an embodiment of the present invention.

### DESCRIPTION OF PREFERRED EMBODIMENTS

According to the present invention, non-rechargeable capacity of a lithium ion secondary battery at high temperatures can be decreased by using halide ion or halogen molecule in the electrolytic solution. Hereafter, a method of reducing the capacity loss of a lithium ion secondary battery by using a capacity loss suppressor will be explained in detail taking iodide ion and iodine molecule as an example.

First, a method and principle of reducing non-rechargeable capacity even in a high temperature environment by adding iodide ion to the electrolytic solution will be explained. The following points have been considered by the inventors before the capacity loss suppressor is adopted.

As a first point, it is necessary that when the capacity loss suppressor is added to the electrolytic solution there will occur no irreversible side reaction which would cause capacity loss of the battery. In particular, the anode contains lithium, which has high reduction reactivity, so that it tends to generate a lithium compound, which is more stable than the simple substance Li. For example, when aluminum ion is added to the electrolytic solution, aluminum is electrocrystallized on the anode, resulting in consumption of lithium which is in the process of being charged. Consequently, it is necessary to increase the content of lithium in the cathode. However, the increased content of lithium leads to a decrease in capacity density of the battery. Such an irreversible capacity loss naturally occurs and is inevitable when a salt of cation other than lithium ion is added to the anode. This is because the potential at which the anode operates is near the potential of lithium, which has the lowest oxidation reduction equilibrium potential among metal elements.

Therefore, the capacity loss suppressor must have a function of not being reduced on the anode, or if reduced, of being oxidized on the cathode to regenerate the capacity loss suppressor.

The latter function, i.e., function of being oxidized on the cathode assures recovery of capacity by recharging, if lithium is consumed on the anode. That the capacity loss suppressor is regenerated means that the battery itself undergoes self-discharging. In other words, even when the capacity suppressor (A) is reduced on the anode and lithium is consumed (formula (1)), the same result as the self-discharge of the battery itself can be obtained (formula (3)), if the capacity loss suppressor is oxidized on the cathode so as to return to the original state (formula (2)).

A+LiC₆→A⁻A⁻+Li⁻+C₆ (1)

A⁻+Li⁺+MO₂→A+LiMO₂ (2)

LiC₆+MO₂→C₆+LiMO₂ (3)

In the above-mentioned formulae, A, LiC₆, A⁻, Li⁺, C₆, MO₂, LiMO₂ have the following meanings.

A: capacity loss suppressor;

LiC₆: LiC₆ obtained by electrochemically storing lithium ion in a graphite layer;

A⁻: a reduced form of the capacity loss suppressor;

Li⁺: lithium ion;

C₆: carbon forming a graphite layer in a discharged state;

MO₂: metal oxide (M represents a metal such as cobalt, nickel, manganese, or iron); and

LiMO₂: metal oxide electrochemically storing lithium ion.

Note that LiC₆ may be replaced by a composition in a charged state in a previous step, i.e., a composition having less lithium inserted such as LiC₁₂ or LiC₁₈.

As a second point, no influence must be given to the chemical and/or physical properties of non-aqueous electrolytic solution. This requirement is intended to endow the battery only with the function of the capacity loss suppressor taking advantage of various properties of the electrolytic solution and allows the electrolytic solution to be selected from a wider range. Such a capacity loss suppressor is suitable since it does neither change the viscosity of the solvent or solubility of the electrolyte nor aggravate various properties of the battery such as charge-discharge efficiency and rate property.

The inventors of the present invention focused on an iodine compound that liberates iodide ion and iodine molecule for use in a non-aqueous electrolytic solution as a capacity loss suppressor that satisfies the above-mentioned two points or requirements. Addition of iodide ion to the electrolytic solution not only does not result in a decrease in efficiency upon ordinary charge-discharge behavior but also allows self-discharge to proceed very slowly upon high temperature storage of lithium. It has been found according to the present invention that the capacity lost due to the self-discharge can be recharged. The same is true for the addition of iodine molecule. In particular, the addition of a small amount of lithium iodide (LiI) or iodine molecule (I₂) is added to the electrolytic solution is most effective for improving charge-discharge efficiency and storage property. These unique properties are explained as follows.

When lithium iodide as an example of the halogen compound is added to the electrolytic solution, iodide ion is dissociated therefrom and comes to be in the electrolytic solution (see formula (4)). The iodide ion reaches the surface of the anode but does not react with lithium in the anode since it is already in a reduced state. This is readily understood electrochemically from the fact that the equilibrium potential of oxidation-reduction reaction of 2I⁻/I₂ is by 3.57 V higher than the equilibrium potential of oxidation-reduction reaction of Li/Li⁺ (see Non-Patent Reference 1 above). On the other hand, although iodine (I₂) can be reduced on the anode (see formula (5)), iodine is not present in an initial stage. Therefore, in the initial stage in which the iodine compound according to the present invention is added, no iodine is generated yet, so that iodide ion is present stably. Formulae (4) and (5) are examples of reactions in which lithium iodide is used. The element iodine may be replaced with fluorine, chlorine or bromine

LiI→Li⁺+I⁻ (4)

I₂+2LiC₆→2I⁻+2Li⁺+C₆ (5)

On the other hand, iodide ion can be present stably on a cathode that has a potential lower than the oxidation-reduction equilibrium potential of 2I⁻/I₂.

However, on a cathode that operates at a potential higher than the oxidation-reduction equilibrium potential of 2I⁻/I₂ (for example, those composed of LiCoO₂, LiMn₂O₄, LiNiO₂ or the like), iodide ions are oxidized to generate iodine (I₂). On this occasion, the cathode that has received electron from iodide ions takes up lithium ions simultaneously. In other words, discharge reaction occurs at the expense of iodide ions (see formula (6)).

2MO₂+2Li⁺+2I⁻→2LiMO₂ +I₂ (6)

M in formula (1) is a metal selected from a series of elements comprising transition metals such as Co, Mn, and Ni.

The cathode active material shown in formula (6) may comprise a material having any optional composition or crystal structure that allows electrochemical insertion/extraction of lithium ions. Note that it is unnecessary that all the lithium ions in the cathode are stored or released into or from the cathode at a potential not lower than the oxidation-reduction equilibrium potential of 2I⁻/I₂. This is because oxidation of iodide ions takes place if a portion of lithium ions is released by charging the cathode at a potential not lower than the above-mentioned equilibrium potential.

If iodine molecules are generated on the cathode, they are diffused from the cathode side to the anode side and reduced on the anode to be converted back to iodide ions. At the same time, lithium in the anode is consumed, and the anode is discharged too. For example, when a carbon anode that allows insertion/extraction of lithium ions is used, the discharge reaction shown by formula (5) takes place.

Then, the iodide ions are oxidized on the cathode to generate iodine again, with the result that the reactions shown by formulae (5) and (6) proceed continuously between the cathode and the anode, so that the battery is slowly discharged. That is, iodine functions as a mediator to cause self-discharge of the battery to proceed.

It is possible that lithium iodide may generate iodine on the anode also by heat. The inventors of the present invention have found that there is a capacity loss in which the capacity of the battery can be recovered by recharge after dipping the charged anode in a non-aqueous electrolytic solution to which lithium iodide is added and retaining the dipped anode at a high temperature not lower than 60° C. (hereafter, referred to as “reversible capacity loss”). Although it is unclear whether this is a scholarly proved reaction and it is not intended to be bound to any theory, this reversible capacity loss would be considered to involve an easily reducible material (i.e., an oxidizing agent) and iodide ion in the electrolytic solution react with each other as accelerated with heat (see formula (7)). In the following formula (7), B stands for an easily reducible material, for example, a small amount of metal ion or hydrogen ion.

2LiI+2B⁺→I₂+2Li⁺+2B (7)

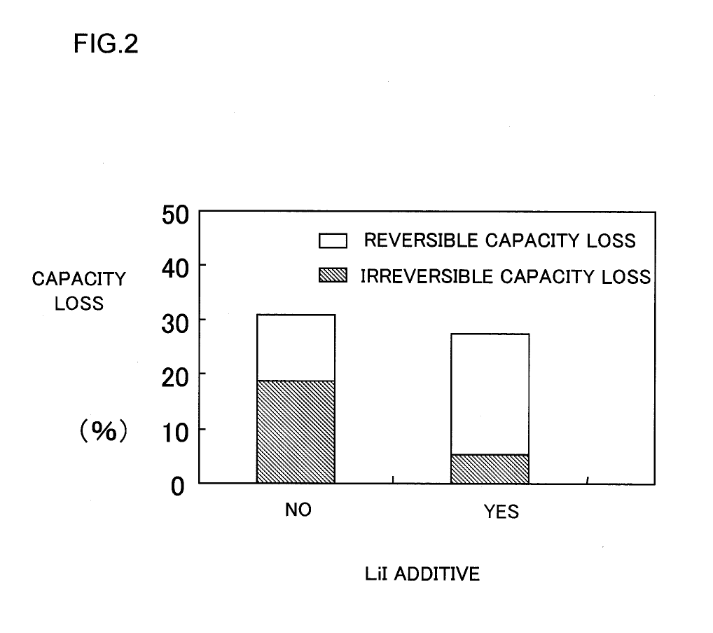

Whether there occurs a reaction with heat depends on further studies. However, results of tests according to the present invention confirmed that coexistence of iodide ion brings about certain stabilizing effect (see FIG. 2 detailed later on).

It is also possible to adopt a method of dissolving iodine molecules (I₂) in a non-aqueous solvent directly in order to achieve oxidation-reduction reaction of 2I⁻/I₂ according to the present invention. If I₂ is present in the electrolytic solution, the reaction shown in formula (5) starts when the battery is charged and if iodide ion is present, it is oxidized again on the cathode (see formula (6)), resulting in that a slow self-discharge reaction shown by formulae (5) and (6) continues.

Similarly, other halogens (fluorine, chlorine and bromine) may be used instead of iodine. That is, oxidation-reduction reactions of 2F⁻/F₂, 2Cl⁻/Cl₂, and 2Br⁻/Br₂ may also be used, respectively.

As described above, the present invention is novel in that (1) irreversible capacity loss is avoided by using a lithium salt, (2) slow self-discharge that involves an oxidation-reduction reaction cycle of halide ion and halogen molecule is used, and (3) halogen molecule is dissolved in a non-aqueous electrolytic solution directly to start the oxidation-reduction reaction cycle.

Now, a method of controlling the slow self-discharge reaction by using the construction of the present invention is explained. As a representative example, a method in which lithium iodide or iodine molecule is added to a non-aqueous electrolytic solution is explained.

The self-discharge reaction when only lithium iodide is added to the electrolytic solution is controlled by the rate of oxidation on the cathode shown by formula (6). Thereafter, reduction reaction on the anode shown by formula (5) comes to contribute, so that the overall reaction rate is determined. Formula (6) can be controlled by adjusting or selecting concentration of iodide ion in the non-aqueous electrolytic solution while formula (5) can be controlled by adjusting or selecting concentration of iodine in the non-aqueous electrolytic solution.

The self-discharge reaction when iodine molecules are added to the electrolytic solution is controlled by the rate of reduction on the anode shown by formula (5). Thereafter, influence of the oxidation reaction shown by formula (6) is added, so that the overall reaction rate is determined. In this case, too, the effects of concentrations of iodine and iodide ion on the respective reaction rates are the same.

Therefore, in both the cases, the self-discharge rate can be controlled by the amount of iodide ion or iodine to be added to the electrolytic solution.

It is desirable that taking advantage of this property, the concentration of iodide ion is set to a low level such that the self-discharge can be suppressed for applications of products whose retention period (or break period) is short and whose energy charged by a single charging is almost entirely utilized. In this manner, the electric energy stored in the lithium ion secondary battery can be used effectively.

On the contrary, it is preferred that the concentration of iodide ion is set at a high level so that the self-discharge of the battery is accelerated and the battery is stored in a discharged state as much as possible for applications of the battery where retention period is long and the battery can be used after it is recharged. In this manner, irreversible capacity loss during the retention period can be prevented.

Also, in the present invention, it is possible to use congeners to iodine (i.e., fluorine, chlorine, and bromine) Since they have respective properties, they should be selected depending on the specification of lithium ion secondary battery and utility thereof as described later on.

Lithium fluoride (LiF) is generally sparingly soluble in non-aqueous solvents due to strong electronegativity of fluoride ion. However, by selecting solvents that are easy to solvate, lithium fluoride can also be used. The oxidation-reduction equilibrium potential of 2F⁻/F₂ is as high as 5.93 V, which is much higher than the equilibrium potential of Li/Li⁺, so that the generation of fluorine (F₂) according to formula (1) will not take place until a 6-V-class high voltage operating type cathode material is selected.

Although lithium chloride (LiCl) is most sparingly soluble next to lithium fluoride, it is still usable by selecting an appropriate solvent. However, note that chloride ions cause corrosion and the like problems of battery containers and collectors. If a material that can avoid these problems is selected, lithium chloride can also be used. The oxidation reduction equilibrium potential of 2Cl⁻/Cl₂ is 4.43 V with respect to the equilibrium potential of Li/Li⁺, so that it is necessary to use lithium chloride in combination with a cathode that operates at 4.5 V or higher (cf. formula (1)).

Lithium bromide (LiBr) is soluble in non-aqueous solvents and is easiest to use next to lithium iodide. The oxidation reduction potential of 2Br⁻/Br₂ is as low as 4.10 V with respect to the equilibrium potential of Li/Li⁺, so that lithium bromide can be used in combination with a 4-V-class cathode. At an oxidation reduction equilibrium potential of 4.1 V or lower with respect to the equilibrium potential of Li/Li⁺, oxidation reaction of from bromide ion to bromine stops. Therefore, lithium bromide is suitable for batteries that operate at a potential higher than the operation potential of the lithium ion secondary battery in which lithium iodide is used.

Iodine has an ion diameter larger than that of other homologous elements and lowest electronegativity among the homologous elements. For this reason, iodide ions tend to release electrons (be oxidized), and tend to be solvated with non-aqueous solvents. Therefore, iodine is easy to use as a mediator for oxidation and reduction. It can be said that iodine is most suitable among the homologous elements for use in 4-V-class lithium ion secondary batteries.

Although lithium ion is most suitable among chemical species that can be selected as cation in the halides, the cation is not limited to lithium ion so far as it does not irreversibly react with constituent elements of the non-aqueous electrolyte secondary battery. Metal ions that react with the above-mentioned constituent elements reduce the capacity of the battery to make it impossible to recharge it, so that they are not suitable for the present invention. For example, not only metal ions are reduced on the anode and charged lithium is consumed but irreversible capacity increases due to formation of a film on the metal (SEI; surface electrolyte interface). Further, it becomes highly possible that micro short-circuiting occurs due to metal dendrites.

Judging the above-mentioned points in a comprehensive manner, lithium salts of homologous elements other than iodide are available. However, lithium iodide or iodine molecule is most excellent for increasing the charge-discharge efficiency and storage property of the battery in a high temperature environment.

It is also believed that in the present invention, the iodide ions do not form a film or a protective film on the anode. This is because lithium iodide is soluble in a non-aqueous electrolytic solution, so that if lithium iodide penetrates into the film or protective film, there is established only concentration equilibrium between the electrolytic solution and the film or the like. Therefore, when the anode is washed with a non-aqueous electrolytic solution or solvent not containing lithium iodide, lithium ion is gradually eluted and eliminated from the film or the like. From this, it can be determined that the lithium iodide does not form any film or the like structure.

Hereafter, a method in which lithium iodide or iodine molecule is added to a non-aqueous electrolytic solution is explained based on specific examples. However, the present invention is not limited to the examples described hereinafter and materials that satisfy some of the above-mentioned requirements can be used. In addition, various modifications may be made without departing from the scope and spirit of the present invention.

First, explanation is made on a method in which lithium iodide is added to a non-aqueous electrolytic solution. The lithium ion secondary battery according to the present invention includes a cathode, a non-aqueous electrolytic solution, and an anode. Generally, the non-aqueous electrolytic solution is contained by a polymeric porous film (so-called a separator).

The cathode includes a cathode active material, a conducting material, a binder, and a collector. Examples of the cathode active material include LiCoO₂, LiNiO₂, LiMn₂O₄, or composite oxides obtainable by replacing the transition metals by other elements. Other materials may be used so far as they are cathode active materials that operate at potentials higher than the oxidation reduction equilibrium potential of iodine.

The particle size of the cathode active material is defined so as to be not larger than the thickness of a binder layer. If there are coarse grains having a size of not smaller than the thickness of the binder layer in powder of the cathode active material, such coarse grains are preliminarily removed by classification using a sieve, classification using air blow or the like to prepare grains having a size of not larger than the thickness of the binder layer.

Since the cathode active material is based on an oxide and hence has high electric resistance, use is made of a conducting material composed of carbon powder in order to make up for electric conductivity. The cathode active material and the conducting material are both powders. The powder is mixed with the binder to bind the grains to each other and allow them to adhere to the collector.

Examples of the collector include aluminum foil having a thickness of 10 to 100 μm, aluminum punched foil having a thickness of 10 to 100 μm and a hole diameter of 0.1 to 10 mm, an expanded metal, a foamed metal plate, and so on. Examples of the material of the collector include, besides aluminum, stainless steel, titanium and so on. In the present invention, any desired collectors may be used and material, form, production method and the like of the collector is not limited.

The cathode can be fabricated by attaching cathode slurry composed of a mixture of the cathode active material, the conducting material, the binder, and an organic solvent on the collector by a doctor blade method, a dipping method, a spraying method or the like, drying the organic solvent off, and pressure molding the cathode by a roll press. It is possible to deposit a plurality of binder layers on the collector by repeating a series of processes of from coating to drying a plurality of times.

The anode includes an anode active material, a binder, and a collector. When high rate charge-discharge is required, a conducting material may be added to the anode. Examples of the anode active material that can be used in the present invention include aluminum, silicon, tin and so on that form alloys with lithium as well as carbonaceous materials that electrochemically store and extract lithium ion, such as graphite and amorphous carbon. In the present invention, the anode material is not particularly limited and materials other those described above may also be used. In particular, the present invention is effective when the anode composed mainly of the carbonaceous material is used.

The anode active material is in general in powder form. The powder is mixed with the binder to bind the grains to each other and allow them to adhere to the collector. The particle size of the anode active material is defined so as to be not larger than the thickness of a binder layer. If there are coarse grains having a size of not smaller than the thickness of the binder layer in powder of the anode active material, such coarse grains are preliminarily removed by classification using a sieve, classification using air blow or the like to prepare grains having a size of not larger than the thickness of the binder layer.

Examples of the collector include copper foil having a thickness of 10 to 100 μm, a copper punched foil having a thickness of 10 to 100 μm and a hole diameter of 0.1 to 10 mm, an expanded metal, a foamed metal plate, and so on. Examples of the material of the collector include, besides copper, stainless steel, titanium, nickel and so on. In the present invention, any desired collectors may be used and material, form, production method and the like of the collector is not limited.

The anode can be fabricated by attaching anode slurry composed of a mixture of the anode active material, the binder, and an organic solvent on the collector by a doctor blade method, a dipping method, a spraying method or the like, drying the organic solvent off, and pressure molding the anode by a roll press. It is possible to deposit a multilayered binder layer on the collector by repeating a series of processes of from coating to drying a plurality of times.

A separator is inserted between the cathode and the anode fabricated as mentioned above to prevent short-circuiting between the cathode and the anode. The separator may be a polyolefin-based polymer sheet made of polyethylene, polypropylene, or the like. Alternatively, the separator may be of a two-layered structure having a polyolefin-based polymer sheet and a fluorine-contained polymer-based polymer sheet made of, for example, polytetrafluoroethylene, fused one on another. To avoid the shrinkage of the separator at elevated temperatures, a mixture of ceramic powder and the binder may be provided in the form of a thin layer on the surface of the separator or an aramide resin layer may be formed on the separator. Since it is necessary for lithium ions to pass through the separators when the battery is charged/discharged, the separators have pores. Generally, separators having a pore diameter in the range of 0.01 to 10 μm and a porosity in the range of 20 to 90% can be used in lithium ion secondary batteries according to the present invention.

The separators are each inserted between a cathode and an anode adjacent to each other to prepare electrodes. The electrodes may be made in various forms. For example, the electrodes may be in the form of a stack of strip-like electrodes, or in the form of electrodes wound into a desired shape such as a cylinder or a flat plate. The electrodes are placed in a battery container which can be hermetically closed with a lid. The shape of the battery container in which the electrodes are placed may assume a cylindrical shape, oblong ellipsoidal shape, a square shape or the like in accordance with the shape of the electrodes.

The material of the battery container is selected from those materials that are corrosion-resistant against non-aqueous electrolytes, such as aluminum, stainless steel, and nickel-plated steel. In case the battery container is electrically connected to the cathode or the anode, the material of the battery container is selected, so that there occurs neither corrosion of the battery container nor alteration of the material of the battery container due to alloy formation with lithium ion where the battery container is in contact with the non-aqueous electrolyte.

The electrodes are placed in the container and terminals of the cathode and the anode are connected to the battery container and a lid, respectively. The electrolytic solution is injected to immerse the electrodes. The electrolytic solution may be directly injected in the container with the lid being open. Alternatively, the container is provided with a lid having an injection hole through which the electrolytic solution can be injected into the container with the lid being closed.

Thereafter, the lid and the battery container are brought into intimate contact with each other to seal the whole battery. In case an injection hole for injecting the electrolytic solution is provided, the injection hole is also sealed. The battery may be sealed by a conventional sealing method such as welding or caulking.

A typical example of the electrolytic solution that can be used in the present invention includes a solution that comprises a mixed solvent containing ethylene carbonate and one or more of dimethyl carbonate, diethyl carbonate, ethyl methyl carbonate, the solution having dissolved therein lithium hexafluorophosphate (LiPF₆) or lithium borofluoride (LiBF₄) as an electrolyte. In the present invention, the types of the solvent and electrolyte and mixing ratios of the solvents are not particularly limited and other electrolytic solutions having different compositions may also used. The electrolyte may be used in a state where it is contained in an ion conducting polymer such as poly(vinylidene fluoride) or polyethylene oxide. In this case, the above-mentioned separator is unnecessary).

The capacity loss suppressor to be added to the electrolytic solution is a material which is dissolved in the electrolytic solution and releases halogen molecule or halide ion to the electrolytic solution. For lithium ion secondary batteries with anodes that operate at 4 V or higher, iodide compounds are particularly suitable. Candidates thereof include lithium iodide (LiI), lithium bromide (LiBr), and lithium chloride (LiCl). Note that although lithium fluoride (LiF) usually is low in solubility and is difficult to handle, it may also be used in combination with a solvent that can dissolve it.

When a solid polymer electrolyte (which may be referred to also as “polymer electrolyte”) is used, lithium halide or halogen molecule is added during film formation of the polymer sheet. In particular, lithium iodide and iodine molecule are suitable. For the solid polymer electrolytes, conventional polymer electrolytes such as polyethylene oxide may be used.

Lithium iodide (LiI) is used as coexisting with the electrolyte dissolved in a non-aqueous solvent. Lithium iodide can be added to the electrolytic solution until its solubility is reached. However, to achieve slow self-discharging by oxidation-reaction reaction of iodide ion according to the present invention, it is necessary to set an upper limit of the concentration of iodide ion. This is because if the iodide ion is in large amounts, self-discharging rate becomes fast, resulting in a decrease in usual charge-discharge efficiency of the lithium ion secondary battery, so that energy storage performance of the battery is decreased.

Accordingly, the amount of iodide ion to be added is set to an appropriate range so that the charge-discharge efficiency of the battery is not substantially decreased and slow self-discharging is realized due to the iodide ion when the battery is stored for a long period of time.

When metal iodides other than lithium iodide are added to the electrolytic solution, always a reduction reaction of metal (cation) occurs on the anode. When the metal iodides other than lithium iodide are used, it is impossible to avoid initial capacity loss due to deposition of the metal (reduction reaction). As a result, an extra amount of the cathode active material is required to make up the capacity loss, so that the battery will have a decreased specific capacity. That is, the initial capacity loss of the battery cannot be avoided. Therefore, the above-mentioned problem of initial capacity loss due to the deposition of metal cannot be solved by the addition of the conventional non-lithium metal iodide to the electrolytic solution.

On the contrary, when lithium ion (Li⁺) is used as the cation, the lithium ion is electrochemically stored in the anode to avoid the problem of capacity loss.

In case a cathode having a potential higher than the oxidation reduction potential of iodine is used, an oxidation reaction of iodine ion proceeds. As a result, if a cathode that operates at 4 V or higher is present, it is in principle impossible to use lithium iodide as electrolyte. Therefore, when lithium iodide is used as the electrolyte, no cathode having a potential higher than the oxidation reduction potential of iodine can be used in batteries.

On the other hand, according to the present invention, use of an electrochemically stable lithium salt as the electrolyte in combination with lithium iodide as a trace additive enables the initial capacity loss of the battery to be avoided and the usage of lithium iodide to be restricted so that lithium iodide can be applied to cathodes that operate at 4 V or higher.

In the present invention, the amount of lithium iodide to be added to the electrolytic solution in terms of concentration is 10 mmol/kg or less. The effect of the present invention is also obtained with a concentration of lithium iodide as low as 0.01 mmol/kg. At a concentration of lithium iodide of less than 0.5 mmol/kg, the effect of the present invention can be obtained without aggravating the energy storage performance.

Use of lithium iodide in high concentrations in the range of 0.5 to 10 mmol/kg is suitable for use in products that are stored or left to stand for a long period of time and have a relatively small ratio of the charge-discharge time to the left-to-stand time. By restricting the concentration of lithium iodide to an appropriate level, self-discharging of the battery can be controlled to a level at which practically no problem occurs. Products suitable for such applications include power sources for machines and tools. The power stored in the lithium ion secondary battery is used only during operation time and remaining power is allowed to be consumed by slow self-discharging by the action of iodide ion to prevent irreversible deterioration of the battery during a long storage period.

On the other hand, use of lithium iodide in low concentrations in the range of 0.01 to 0.1 mmol/kg is suitable for use in products that are left to stand for a short period of time and have a relatively large ratio of the charge-discharge time to the left-to-stand time, for example, backup power sources that perform float charging. This is because it is necessary to retain the battery in a full charge state under usual conditions, so that it is desirable that the self-discharge rate of the battery is set to a low level and the capacity retention of the battery is set to a high level.

Moreover, use of lithium iodide in medium concentrations in the range sandwiched by the high and low concentration ranges in the range of 0.1 to 0.5 mmol/kg is suitable for use in products for which there is not so much a difference between the charge-discharge time and the left-to-stand time. Such products include, for example, products that are expected to have cycles of charge and discharge in a day, such as electric vehicles and stationary energy storage systems. Note that products to which the present invention is applicable are not limited by the above-mentioned concentration ranges but instead appropriate concentration ranges should be selected according to the manner in which the lithium ion secondary battery is used.

The amount of lithium iodide to be added can be determined by the following procedure. That is, the inside of the battery is washed with original non-aqueous electrolytic solution or at least one solvent when a mixed solvent is used to extract lithium iodide and electrolyte. In this case, a solid content such as precipitate, for example, scraping from the electrodes is removed by centrifugation or the like and only a transparent non-aqueous electrolytic solution (extract) is obtained.

For quantitative determination of iodide ion in the extract, conventional analytical techniques including iodine titration, ion chromatography, or an analytical method using iodine titration or ion chromatography in combination with mass spectrum analysis. In case the electrolyte contains iodine and it is necessary to distinguish the iodine in the electrolyte from iodine in the lithium iodide, the above-mentioned extract is subjected to nuclear magnetic resonance analysis method, infrared spectroscopy, ion chromatography or the like to determine the electrolyte.

The total amount of lithium iodide dissolved in the electrolytic solution (dissociable LiI) can be extracted by washing the components of the battery as described above. The layer of lithium iodide (LiI) in the coat described in Patent Reference 3 cited above is considered to exist in a chemically stable state, so that dissociable LiI can be distinguished from the coat

Alternatively, the existence of iodide ion can be confirmed by using the whole battery as follows. When the battery itself is heated at a high temperature, iodine ion in the electrolytic solution is oxidized on the cathode to form iodine molecules (I₂). The iodine molecules evaporate as iodine gas along with evaporation of the solvent in the electrolytic solution. The evaporated gas can be detected by gas chromatography and mass spectroscopy analysis.

In addition, by using the above-mentioned method, the dissociable LiI can be distinguished from LiI in the electrode coat. This is because LiI in the state of salt will not be evaporated. Of course, it is possible to perform analysis of iodine as iodine gas (I₂) by extracting the electrolytic solution from the battery and heating it.

In addition to the method according to the present invention in which the capacity loss suppressor is dissolved in the electrolytic solution, a method in which the capacity loss suppressor is added to the anode is also effective. Fine powder of lithium halide is simply mixed with the anode active material and the binder and the obtained mixture is applied to the collector to form an anode thereon. Alternatively, lithium halide and a polymer and the like may be mixed to coat the lithium halide in the inside of the polymer in the form of a capsule and the encapsulated halide is introduced into the inside of the battery or coated on the surface of the electrode.

Moreover, a method in which a capacity loss suppressor is thinly coated on the surface of the separator may be adopted. That is, lithium halide can be added, mixed and dispersed into the inside of separators in the step of forming a film on the separators.

In case a polymer electrolyte is used, lithium halide may be dispersed in the inside of the polymer. This is achieved by mixing powder of the capacity loss suppressor with the polymer in the step of forming a polymer sheet.

In the light of the above explanation, the effects of the present invention will be described by specific embodiments. Note that specific constituent materials, components and so on may be changed so far as the gist of the present invention is not changed. In addition, so far as the constituent elements of the present invention are included, one or more known technologies may be added thereto or some part of the present invention may be replaced by one or more known technologies.

### First Embodiment

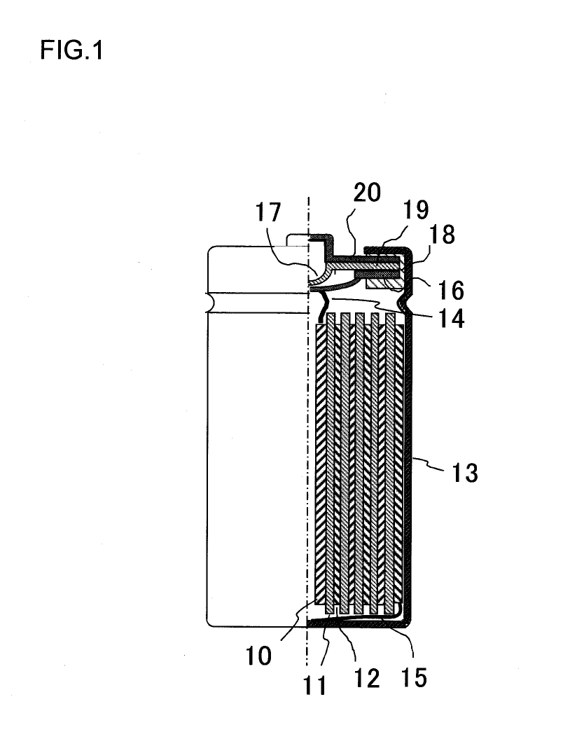

FIG. 1 shows an inside structure of the lithium ion secondary battery according to the present invention. The lithium ion secondary battery includes a cathode 10, a separator 11, an anode 12, a battery can 13, a cathode collector tab 14, an anode collector tab 15, an inner lid 16, an inner pressure release valve 17, a gasket 18, a positive temperature coefficient (PTC) resistive element 19, and a battery lid 20. The battery lid 20 is an integrated component that includes the inner lid 16, the inner pressure valve 17, the gasket 18, and the PTC resistive element 19.

The cathode 10 is fabricated by the following procedure. LiMn₂O₄ is used as a cathode active material. To 85.0 mass parts of the cathode active material are added 7.0 mass parts of graphite powder and 2.0 mass parts of acetylene black as a conducting material. Further, a solution of 6.0 mass parts of polyvinylidene fluoride (hereafter, referred to as “PVDF”) as a binder in 1-methyl-2-pyrrolidone (hereafter referred to as “NMP”) is added. The obtained mixture is mixed using a planetary mixer followed by mixing the obtained slurry under vacuum in order to remove bubbles therein to prepare homogeneous cathode binder slurry. This slurry is coated uniformly and homogeneously on both sides of a 20-μm-thick aluminum foil using a coating machine. After the coating, the coated foil is compression molded by using a roll press to an electrode density of 2.55 g/cm³. The obtained cathode is cut by using a slitter to fabricate a cathode of 160 μm in thickness, 900 mm in length, and 54 mm in width.

The anode 12 is fabricated in the following procedure. Synthetic graphite powder having an average particle size of 20 μm is used as an anode active material. To 95.0 mass parts of the anode active material is added a solution of 5.0 mass parts of PVDF dissolved in NMP as a binder. The obtained mixture is mixed to obtain slurry, which is then mixed using a planetary mixer under vacuum to remove bubbles therein to prepare homogeneous anode binder slurry. This slurry is coated on both sides of a 10-μm-thick rolled copper foil using a coating machine uniformly and homogenously. After the coating, the electrodes are compression molded using a roll press machine to an electrode density of 1.3 g/cm³. The obtained anode is cut by using a slitter to fabricate a cathode of 110 μm in thickness, 950 mm in length, and 56 mm in width.

Collector tabs 14 and 15 are ultrasonically welded to non-coated areas (collector exposed sides) of the cathode 10 and the anode 12 thus fabricated, respectively. The collector tab 14 for the cathode is an aluminum lead strip and the collector tab 15 for the anode is nickel lead strip. Then, the separator 11, which is made of a porous polyethylene film of 30 μm in thickness, is inserted between the cathode 10 and the anode 12. The cathode, the separator 11, and the anode 12 are wound. The obtained winding is placed in the battery can 13 and the anode tab 15 is connected to the bottom of the battery can 13 using a resistance welder. The cathode tab 14 is connected to the bottom of the inner lid 16 by ultrasonic welding.

The non-aqueous electrolytic solution according to the present invention is injected into the inside of the battery can 13 before the upper lid, i.e., the battery lid 20 is attached to the battery can 13. The solvent of the electrolytic solution consist of ethylene carbonate (EC), dimethyl carbonate (DMC), and diethyl carbonate (DEC) in volume ratios of 1:1:1. The electrolyte used is 1 mole/liter (about 0.8 mol/kg) of LiPF₆. In addition, 1 mmol/kg equivalent of lithium iodide according to the present invention is added to the non-aqueous electrolytic solution. The obtained electrolytic solution is dripped from above the electrodes. Then, the battery lid 20 and the battery can 13 are caulked together to seal the battery to obtain a lithium ion secondary battery. The sample battery thus obtained is named LIB1. Note that five batteries having the same specification are fabricated.

Similarly, a lithium ion secondary battery is fabricated in which components other than lithium iodide (solvent, electrolyte, electrodes, separator, battery can, battery lid, and so on) are of the same specifications and iodine instead of lithium iodide is dissolved in the electrolytic solution. The amount of iodine molecule added is 0.5 mmol/kg and the mole number of iodine element in the electrolytic solution is set to be the same as that of iodine in LIB1. This sample battery is named LIB2. Note that five batteries of the same specification are fabricated.

As a comparison, a lithium ion secondary battery in which neither lithium iodide nor iodine is added to the electrolytic solution is fabricated. This sample battery is named LIB3. Note that five batteries of the same specification are fabricated.

These three types of batteries are charged at a constant current of 0.3 A (corresponding to 0.3 CA in rate) to a voltage of 4.2 V and then at a constant voltage of 4.2 V for 2 hours. After the charging, the battery is left to stand to be discharged at 0.3 A. The discharging is stopped when 3.2 V is reached. Subsequently, the above-mentioned charge-discharge cycle is repeated 10 times before the initial capacity is obtained. The initial capacities of the batteries are 1015±10 mAh, 1010±10 mAh, and 1020±10 mAh, respectively. Note that the tests are performed at room temperature.

At 11th cycle in the above mentioned tests, each battery is charged under the above-mentioned conditions and the tests are completed in full a charge state. The batteries are stored in a constant-temperature oven at 60° C. and left to stand therein for 20 days. After the standing, tests are started from discharging under the above-mentioned charge-discharge conditions. Subsequently, the charge-discharge cycle is repeated 5 times and discharge capacity at the last cycle is measured and defined as retention capacity (dischargeable capacity after recharging). Table below shows results of the tests.

| | TABLE | | | | | | |
|---|---|---|---|---|---|---|---|
| | Battery Name | | | | | | |
| | LIB1 | LIB2 | LIB3 | LIB4 | LIB5 | LIB6 | LIB7 |
| Solvent | EC + DMC + DEC (Mixing Ratio = 1:1:1) | | | | | | |
| Electrolyte | 1 mol/liter LiPF₆ | | | | | | |
| Amount of LiI | 1 | 0 | 0 | 0.001 | 0.1 | 0.5 | 10 |
| (mmol/kg) | | | | | | | |
| Amount of I₂ | 0 | 0.5 | 0 | 0 | 0 | 0 | 0 |
| (mmol/kg) | | | | | | | |
| Initial Capacity | 1015 ± 10 | 1010 ± 10 | 1020 ± 10 | 1018 ± 10 | 1017 ± 10 | 1014 ± 10 | 1013 ± 10 |
| (mAh) | | | | | | | |
| Number of days of | 20 | 20 | 20 | 20 | 20 | 20 | 20 |
| standing at 60° C. | | | | | | | |
| Initial discharge | 705 ± 15 | 710 ± 15 | 680 ± 15 | 700 ± 15 | 705 ± 15 | 710 ± 15 | 710 ± 15 |
| capacity after | | | | | | | |
| standing (mAh) | | | | | | | |
| Dischargeable | 965 ± 15 | 970 ± 15 | 805 ± 15 | 930 ± 15 | 945 ± 15 | 975 ± 15 | 980 ± 15 |
| capacity after | | | | | | | |
| recharging (mAh) | | | | | | | |

As a result, the initial discharge capacities after the left-to-stand (standing) are 705±15 mAh for LIB1, 710±15 mAh for LIB2, and 680±15 mAh for LIB3. The retention capacities after the standing are 965±15 mAh for LIB1, 970±15 mAh for LIB2, and 805±15 mAh for LIB3. From the results it can be seen that there is no great difference in capacity loss after the standing among the batteries whereas retention capacities (dischargeable capacities after recharging) differ to a greater extent among the batteries. LIB1 and LIB2 in which the capacity loss suppressor according to the present invention is used exhibit excellent capacity retention property.

### Second Embodiment

Further, lithium ion secondary batteries LIB4, LIB5, LIB6, and LIB7 are fabricated using the same battery components such as electrodes as used in LIB1 with different amounts of lithium iodide. The amounts of lithium iodide used in the batteries are as shown in Table 1 above, i.e., 0.01, 0.1, 0.5, and 10 mmol/kg, in this order.

Next, each battery is charged under the above-mentioned conditions and the tests are completed in a full charge state. The batteries thus obtained are stored as they are in a constant temperature oven at 60° C. and left to stand therein for 20 days. After the standing, tests are started from discharging under the above-mentioned charge-discharge conditions. Subsequently, the charge-discharge cycle is repeated 5 times and discharge capacity at the last cycle is measured and defined as retention capacity (dischargeable capacity after recharging). Table 1 below shows results of the tests.

There is a tendency that the initial discharge capacity of the battery after the standing increases slightly as the amount of lithium iodide added decreases (e.g., LIB4) and decreases as the amount of lithium iodide added increases (e.g., LIB7). A reverse tendency is observed concerning dischargeable capacity after recharging. That is, the initial discharge capacity of the battery after the standing decreases as the amount of lithium iodide added decreases (e.g., LIB4) and increases as the amount of lithium iodide added increases (e.g., LIB7). This indicates that the capacity loss suppressor according to the present invention is effective for storing lithium ion secondary batteries at high temperatures for a long period of time. Note that any of batteries LIB4, LIB5, LIB6, and LIB7 according to the present invention has a dischargeable capacity after recharging higher than that of LIB3 in which lithium iodide is not added and exhibit excellent capacity retention property.

Note that the initial discharge capacity after standing tends to increase as the amount of lithium iodide added decreases for a time range of, for example, within 1 day after standing at 60° C. for a short period of time. However, the dischargeable capacity after recharging of any of LIB1, LIB2, LIB4, LIB5, LIB6, and LIB7 is greater than that of LIB3.

### Third Embodiment

Lithium ion secondary batteries are fabricated in which the lithium iodide in LIB4, LIB5, LIB6, and LIB7 is replaced by iodine molecule. The amounts of iodine molecule are ½ time the amounts of the lithium iodide shown in Table 1 in molar concentration so that the same amount of the capacity loss suppressor is present in terms of iodine element for each battery.

As a result, even after lithium iodide is replaced by iodine, LIB4, LIB5, LIB6, and LIB7 corresponding to the respective concentrations exhibit substantially the same values with fluctuations in the range of ±5% with respect to both the initial discharge capacity after standing and the dischargeable capacity after recharging. These results verify that replacement of lithium iodide by iodine can give same results.

### Fourth Embodiment

FIG. 2 shows results of evaluation of capacity retention property of batteries conducted by dipping only the anode used in the above-mentioned embodiment in the electrolytic solution according to the present invention, placing them in a sealed metal container, and storing the container at a high temperature. The sealed metal container may be a commercially available stainless steel container, for example, UNION manufactured by SWAGELOK COMPANY with a plug on each side.

The electrolytic solution has the same composition as the solution used for LIB1 and LIB3 used in the above-mentioned embodiments. The standing temperature is 60° C. Batteries are left to stand for 30 days. The initial discharge capacity after the standing is a product of a value of a difference obtained by subtracting reversible capacity loss (%) and irreversible capacity loss (%) in FIG. 2 from 100% and multiplying the obtained difference by capacity of battery before the standing. The dischargeable capacity after recharging is a product of a value obtained by subtracting irreversible capacity loss (%) from 100% and multiplying the obtained difference by capacity of battery before the standing. As will be apparent from the results shown in FIG. 2, there is no considerable difference in the ratio of capacity loss immediately after standing (sum of reversible capacity loss and irreversible capacity loss) whether or not the electrolytic solution according to the present invention is used. However, the irreversible capacity loss when the capacity loss suppressor according to the present invention is added is decreased to ¼ or less time the irreversible capacity loss when such is not added. As a result, it revealed that the lithium ion secondary battery according to the present invention has excellent dischargeable capacity after recharging (reversible capacity loss). This is ascribable to the effect of iodide ion according to the present invention to allow slow self-discharging, thereby suppressing inactivation of the anode.

Moreover, the method of the present invention is featured by being different from the conventional methods not only in construction but also in the effect obtained by the action of iodide ion or iodine as described below.

In the case of stable coating formation by the conventional technology, it is possible that the coating prevents direct contact between the anode and the electrolytic solution, in particular the solvent, so that it serves to lower decomposition rate of the solvent. That is, the coating serves as a so-called protective coat. Therefore, on the anode formed with the coat, as compared with the one not formed with any coat, irreversible capacity loss and reversible capacity loss occur in the same ratio. This is because the reaction after the solvent, which has passed through the coat, reaches the surface of the anode is substantially the same electrochemical reaction as the one that proceeds when no stable coat has been formed. State differently, only the transmission rate of the solvent that migrates through the coat is changed and the ratio of electrochemical reaction rates that lead to irreversible capacity loss and reversible capacity loss, respectively, is not changed.

However, in case the capacity loss suppressor (e.g., lithium iodide) according to the present invention is added to the electrolytic solution, as compared with the case where no capacity loss suppressor is added, a unique effect can be obtained in that although the total capacity loss is not changed, the irreversible capacity loss is relatively decreased and the reversible capacity loss is increased accordingly. It follows from this that the effect of addition of the capacity loss suppressor is not attributable to formation of the coat.

Even if LiI is incorporated into the coat to form a stable coat, there occurs no electrochemical electron transfer (see formula (8)). Here, LiI (solution) means a state before dissociation when LiI is added to the solution. Li⁺ (solution) and I⁻ (solution) mean each a state of ion after dissociation of LiI. LiI (coat) means a state in which LiI is incorporated into the coat and stabilized. It is obvious that no transfer of electros occurs until LiI (solution) is stabilized to (coat) in the reaction formula (8).

LiI (Solution)→Li (Solution)±I⁻ (Solution)→LiI (Coat) (8)

From the above discussion, it can be concluded that the capacity loss suppressor according to the present invention participates in at least one of (a) oxidation reduction reaction (formulae (4) to (6)) that involves oxidation on the cathode and reduction on the anode and (b) thermal acceleration reaction (formula (7)) and oxidation reduction reaction (formula (5)), thereby enabling slow self-discharging and reversible charging. Such a unique function is not realized by the conventional technology.

While this invention has been particularly shown and described with reference to preferred embodiments thereof, it will be understood by those skilled in the art that various changes in form and details may be made therein without departing from the spirit and scope of the invention as defined by the appended claims.

What is claimed is:

1. A lithium ion secondary battery comprising:
a cathode that stores/releases lithium ion at a potential not lower than an oxidation-reduction equilibrium potential between halogen ion and halogen;
an anode that stores/releases lithium ion; and
a non-aqueous electrolytic solution composed of a non-aqueous solvent having dissolved therein an electrolyte,
wherein
the non-aqueous electrolytic solution contains lithium halide or a halogen molecule.

2. A lithium ion secondary battery according to claim 1, wherein
the content of the lithium halide or the halogen molecule is in the range of 0.01 to 10 mmol/kg in terms of halogen based on weight of the non-aqueous electrolytic solution.

3. A lithium ion secondary battery according to claim 1, wherein
the lithium halogen or the halogen molecule adsorbed on a surface of the anode is removable by washing with the non-aqueous solvent.

4. A lithium ion secondary battery according to claim 1, wherein
the halogen ion is iodide ion and the halogen molecule is iodine molecule.

5. A lithium ion secondary battery according to claim 1, wherein
the anode comprises a material selected from the group consisting of carbon, a metal that forms an alloy with lithium, and mixtures thereof

6. A lithium ion secondary battery according to claim 1, wherein
the anode comprises a material containing carbon.

7. A lithium ion secondary battery comprising:
a cathode that stores/releases lithium ion at a potential not lower than an oxidation-reduction equilibrium potential between halogen ion and halogen;
an anode that stores/releases lithium ion; and
a polymer solid electrolyte containing an electrolyte,
wherein
the polymer solid electrolyte contains lithium halide or a halogen molecule.

8. A lithium ion secondary battery according to claim 7, wherein
the content of the lithium halide or the halogen molecule is in the range of 0.01 to 10 mmol/kg in terms of halogen based on weight of the non-aqueous electrolytic solution.

9. A lithium ion secondary battery according to claim 7, wherein
the halogen ion is iodide ion and the halogen molecule is iodine molecule.

10. A lithium ion secondary battery according to claim 7, wherein
the anode comprises a material selected from the group consisting of carbon, a metal that forms an alloy with lithium, and mixtures thereof.

11. A lithium ion secondary battery according to claim 7, wherein
the anode comprises a material containing carbon.

12. A lithium ion secondary battery comprising:
a cathode that stores/releases lithium ion at a potential not lower than an oxidation-reduction equilibrium potential between halogen ion and halogen;
an anode that stores/releases lithium ion, containing carbon; and
an electrolyte,
wherein
the electrolyte contains an inorganic redox shuttle,
the cathode stores/releases lithium at a potential not lower than an oxidation-reduction equilibrium potential of the inorganic redox shuttle.

13. A lithium ion secondary battery according to claim 12, wherein
the inorganic redox shuttle comprises halogen.

14. A lithium ion secondary battery according to claim 13, wherein
the content of the halogen is in the range of 0.01 to 10 mmol/kg based on weight of the non-aqueous electrolytic solution.

15. A lithium ion secondary battery according to claim 13, wherein
the halogen is iodine.

16. A lithium ion secondary battery comprising:
a cathode that electrochemically insert/extract lithium ion;
an anode that electrochemically insert/extract the lithium ion; and
an electrolyte, wherein
the electrolyte comprises an oxidation-reduction reaction system coupled with the electrochemical insertion/extraction reaction of the lithium ion,
the cathode stores/releases lithium at a potential not lower than an oxidation-reduction equilibrium potential of the oxidation-reduction system.

17. A lithium ion secondary battery according to claim 16, wherein
the oxidation-reduction system comprises halogen ion and a halogen molecule.

18. A lithium ion secondary battery according to claim 16, wherein
the content of the halogen is in the range of 0.01 to 10 mmol/kg based on weight of the non-aqueous electrolytic solution.

19. A lithium ion secondary battery according to claim 16, wherein
the halogen ion is iodide ion and the halogen molecule is iodine molecule.
